(19) United States
(12) Patent Application Publication
(10) Pub. No.: US 2021/0224801 A1
(43) Pub. Date: Jul. 22, 2021

(54) METHOD AND DEVICE FOR PREVENTING A DOUBLE SPEND ATTACK

(71) Applicant: HONGFUJIN PRECISION ELECTRONICS(TIANJIN)CO.,LTD., Tianjin (CN)

(72) Inventor: SHIH CHUN WANG, New Taipei (TW)

(21) Appl. No.: 16/990,136

(22) Filed: Aug. 11, 2020

(30) Foreign Application Priority Data
Jan. 21, 2020 (CN) 202010070702.2

(51) Int. Cl. G06Q 20/40; G06Q 20/06

(52) U.S. Cl. CPC G06Q 20/401; G06Q 20/065

(57) ABSTRACT

A method to prevent a double spend attack in cryptocurrency transactions recorded in a blockchain can be applied in a device. The device acquires transaction information, the information comprising a type of virtual currency and a transaction amount, and acquires currency price according to the virtual currency type. The device further calculates a transaction value according to the currency price and the transaction amount of the virtual currency, calculates a unit attack cost corresponding to a blockchain network of the virtual currency, adjusts a quantity of the records indicating that a transaction is recorded by the blockchain network to make a total attack cost greater than a transaction value of the transaction, and transmits transaction information of the transaction to the blockchain network.

This application claims priority to Chinese Patent Application No. 202010070702.2 filed on Jan. 21, 2020, the contents of which are incorporated by reference herein.

### FIELD

The subject matter herein generally relates to blockchain technology, especially relates to a method and a device for preventing a double spend attack.

### BACKGROUND

Double spend attacks on cryptocurrency transactions is when an attacker controls blockchain calculation power to rewrite a block after an exchange has become a transaction, invalidating the previous blockchain transaction, even though the attacker has already received cash. Specifically, a fixed confirmation number is determined based on different currencies in exchange. When a transaction amount is large, a cyber attacker will add more than 51% of the blockchain calculation power to process accounting rights of the entire blockchain and tamper with the contents of blockchain transactions in a period of time corresponding to the fixed confirmation number. After the exchange confirms that the cryptocurrency transactions form a trusted transaction, the cyber attacker will withdraw blockchain calculation power from the blockchain, causing the cryptocurrency transactions to fail, and returning the cryptocurrency to the cyber attacker, thus a double spend attack attempts to obtain goods and the return of his money. If the double spend attack cannot be voided, it can cause losses to the exchange or a seller of goods of the cryptocurrency and disrupt the trading order of the cryptocurrency.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a device for preventing a double spend attack.

FIG. 2 is a block diagram of an embodiment of a system for preventing a double spend attack.

FIG. 3 is a flowchart of an embodiment of a method for preventing a double spend attack.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

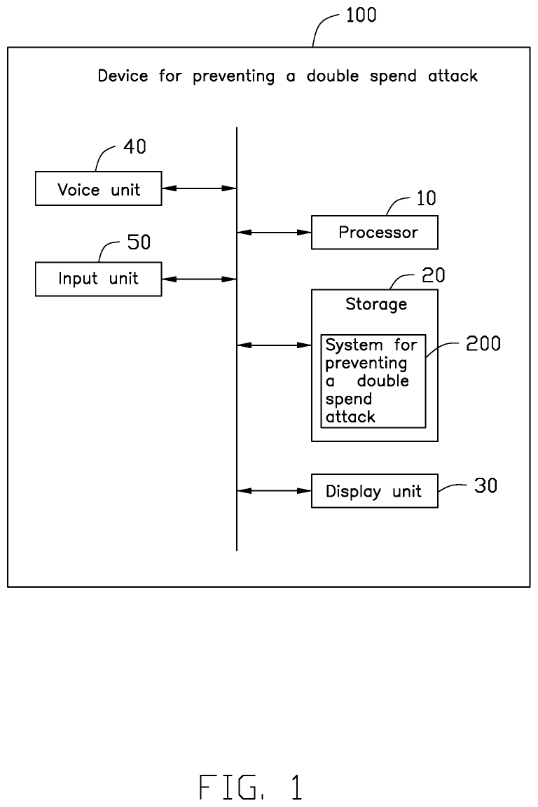

FIG. 1 illustrates a device 100 for prevent a double spend attack. The device 100 includes a processor 10, a storage 20, a display unit 30, a voice unit 40, and an input unit 50. In one embodiment, the processor 10 can be a central processing unit, or a common processor, a digital signal processor, a dedicated integrated circuit, ready-made programmable gate arrays or other programmable logic devices, discrete door or transistor logic devices, discrete hardware components, and so on. In another embodiment, the processor 10 can be a microprocessor or any conventional processor. The processor 10 can also be a control center of the device 100 to prevent the double spend attack, using interfaces and lines to connect the parts of the device 100.

In one embodiment, the storage 20 stores data and computer programs, for example, the storage 20 stores images and image models. In one exemplary embodiment, the storage 20 can include various types of non-transitory computer-readable storage mediums. For example, the storage 20 can be a flash memory, a random access memory (RAM) for temporary storage of information, a read-only memory (ROM) for permanent storage of information, a programmable read-only memory (PROM), an erasable programmable read-only memory (EPROM), a one-time programmable read-only memory (OTPROM), an electrically-erasable programmable read-only memory (EEPROM). In another embodiment, the storage 20 can also be an external storage system, such as a hard disk, a storage card, or a data storage medium.

The display unit 30 displays various information. In one embodiment, the display is a monitor, or a touch screen. The voice unit 40 is used to present a variety of information audibly, such as playing transaction progress, playing an alarm prompt. In the voice unit 40 is a speaker or other voice device. The input unit 50 is used to input information. In one embodiment, the input unit 50 can be a keyboard, or a touch screen. In one embodiment, the processor 10, the storage 20, the display unit 30, the voice unit 40, and the input unit 50 can be integrated into a computer device. In other embodiments, the display unit 30, the voice unit 40, and the input unit 50 can also be omitted.

In one embodiment, the device 100 can be a desktop computer, a notebook, a handheld computer, a cloud server or other computing device. It will be understood that the schematic of FIG. 1 is only an example of the device 100 for prevent a double spend attack, and does not constitute a qualification or limitation for the device 100, other examples of such device may include more parts or less parts than the embodiment illustrated in FIG. 1. The device 100 may also include network access equipment, and buses, etc.

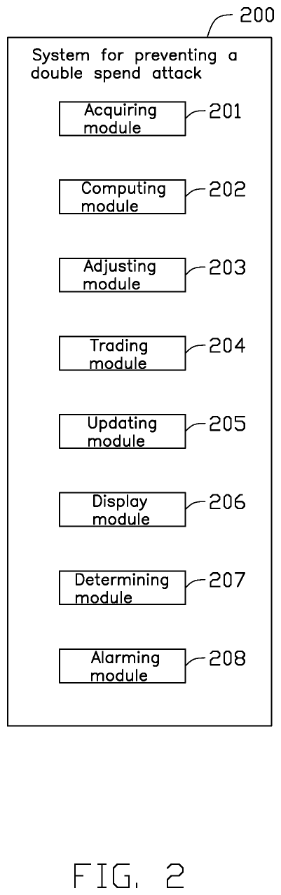

FIG. 2 illustrates a system 200 for preventing a double spend attack. In one embodiment, the system 200 includes a series of computer instruction in the form of one or more programs, and the computer instruction in the form of one or more programs is stored in the storage 20 and executed by the processor 10, in order to realize the required functions. In one embodiment, the system 200 includes an acquiring module 201, a computing module 202, a adjusting module 203, a trading module 204, an updating module 205, a display module 206, a determining module 207, and an alarming module 208. In one embodiment, the modules 201-208 of the system 200 can be collections of software instructions. In the present embodiment, the acquiring module 201, the computing module 202, the adjusting module 203, the trading module 204, the updating module 205, the display module 206, the determining module 207, and the alarming module 208 are stored in the storage 20 of the device 100 and executed by the processor 10. In another embodiment, the acquiring module 201, the computing module 202, the adjusting module 203, the trading module 204, the updating module 205, the display module 206, the determining module 207, and the alarming module 208 are program segments or code in the processor 10 of the device 100.

The acquiring module 201 acquires transaction information, wherein the transaction information includes a type of virtual currency type and a transaction amount of the virtual currency. In one embodiment, the acquiring module 201 acquires the transaction information of a pending transaction by the input unit 50.

In one embodiment, the acquiring module 201 further acquires currency price according to the virtual currency type. The currency price may be an actual price, that is, a transaction price of the virtual currency at instant moment, or an estimated price, which is an average of the trading price over a period of time.

The computing module 202 calculates a transaction value according to the currency price and the transaction amount. In one embodiment, the transaction value is an actual value of the virtual currency. The computing module 202 calculates the transaction value by multiplying the currency price by the transaction amount of the virtual currency.

In one embodiment, the acquiring module 201 acquires a total computing power of a blockchain network according to the virtual currency type. The computing power is a hash rate, and the computing power is an unit of measurement for the blockchain network processing power. Specifically, the computing power is an outputting speed for a computer to calculate a hash function.

In one embodiment, the total computing power of the blockchain network can be an actual computing power value of the blockchain network at present moment, or an average computing power over a period of time, or a pre-estimated computing power value. For example, the total computing power of the blockchain network can be estimated according to a time and a bill difficulty experienced by a competition of absenteeism and accounting rights in the blockchain network during a preset time. In one embodiment, the total computing power of the blockchain network can be a computing power of all mining machines on the blockchain network.

The computing module 202 calculates a unit computing cost according to the total computing power of the blockchain network.

In one embodiment, the computing module 202 calculates unit computing power according to the total computing power of the blockchain network, and calculates unit computing cost according to the unit computing power, a hardware cost, and an electricity cost. In one embodiment, the hardware cost includes a purchase cost of the mining machines on the blockchain network and a rental cost, the cost of electricity includes electricity consumed by the mining machines. In one embodiment, the unit computing cost includes a technology cost, a labor cost, and a cost of maintaining the mining machines.

In one embodiment, the computing module 202 calculates a computing time of each block in the blockchain network. In bitcoin blockchain network, building a block in the bitcoin blockchain may actually take 10 minutes, and the new block is broadcast to the entirety of network nodes of the blockchain network. Due to a fluctuation of the total computing power of the blockchain network, the time cost by the bitcoin blockchain to build the block may be different, for example, the time can be 10 minutes and 30 seconds, or can be 9 minutes and 30 seconds.

In one embodiment, the computing time can be a time period of building a new block in the blockchain network, or an average of a number of build times of multiple blocks in the blockchain network.

In one embodiment, the computing module 202 calculates a unit attack cost according to the computing time and the unit computing cost.

In one embodiment, the computing module 202 calculates the unit attack cost of the double spend attack according to formula P0=p1*S*p2, where p1 is the computing time of each block in the blockchain network, S is the number of blocks built by the attack, and P2 is unit attack cost. For example, the total computing power of the blockchain network is computing power of 100, and the attacker needs to control at least 50% of the total computing power in the blockchain network to launch a double spend attack, computing power of 51 is sufficient. A trader initiates a transaction and sends a true transaction order to the blockchain network, the attacker generates a fake transaction order, and uses a “minority obeys majority” principle in a consensus mechanism to implement a fake transaction order. Such a fake transaction order is to replace the true transaction order and write the fake to a block of the blockchain network, causing the true transaction order to be deleted or tampered with by other target service nodes of the blockchain network. The computing module 202 calculates the unit attack cost of the double spend attack according to formula P0=p1*51*p2, where p1 is the computing time of each block in the blockchain network, 51 is the number of blocks built by the attack, and P2 is unit attack cost.

In one embodiment, the computing module 202 acquires a maximum computing power of one node in the blockchain network according to the virtual currency type, and calculates the unit attack cost according to maximum computing power of one node in the blockchain network, the computing time, and the unit computing cost.

In one embodiment, the note corresponding to the maximum computing power has a maximum probability value of the accounting rights in the blockchain network. The unit attack cost is not less than a value determined by the maximum computing power multiplying the computing time and the unit computing cost.

The adjusting module 203 adjusts a quantity of the records indicating that a certain transaction is recorded by the blockchain network to make a total attack cost greater than a transaction value of the transaction. In one embodiment, the total attack cost is determined by multiplying the quantity of the records with the unit attack cost. In one embodiment, the quantity of the records is N and when the transaction occurs, a target block in the blockchain network recording the transaction will be recorded for the first time, and (N−1) records will be recorded in the blocks behind the target block. In one embodiment, the quantity of the records and the transaction are time-stamped on the blockchain, making the quantity of the records and the transaction irreversible and not subsequently alterable. When the quantity of the records reaches a preset quantity of the records, the transaction is successful.

In one embodiment, the adjusting module 203 periodically adjusts the quantity of the records according to unit attack cost of the double spend attack, and the transaction value of the transaction to make the total attack cost greater than a transaction value of the transaction. The total attack cost is calculated according to formula P=P0*N, wherein N is the quantity of the records, and P is total attack cost.

In one embodiment, the adjusting module 203 periodically acquires the currency price, the total attack cost, the unit attack cost, the computing time, and the maximum computing power of one node in the blockchain network. The quantity of the records is adjusted when it is detected that any one of the currency price, the total attack cost, the unit attack cost, the computing time, and the maximum computing power of one node in the blockchain network, is changed.

Since the transaction time of virtual currency is relatively long, there are many factors affecting the transaction value of the virtual currency, such as virtual currency price surge, mining machine rent fluctuations, electricity price adjustment, and total computing power. The transaction value or unit attack cost needs to be calculated according to the virtual currency price in most recent cycle period, and the quantity of the records is adjusted according to the transaction value or unit attack cost. The length of cycle period can be set according to the capability of the mining machine and the fluctuation of the virtual currency, for example, the cycle period can be five minutes.

In one embodiment, when at least one trusted node in the blockchain network has more computing power than that of the other nodes in the blockchain network, the adjusting module 203 adjusts the quantity of the records to a target quantity of the records. In one embodiment, the target quantity of the records is a minimum quantity of the records in completing the transaction. In one embodiment, the trusted node can be a blockchain node for the trader himself, or another blockchain node that the trader can trust.

The trading module 204 transmits transaction information to the blockchain network. In one embodiment, the trading module 204 broadcast transaction information to the blockchain network to request the blocks in the blockchain network to record the transaction information.

In one embodiment, the acquiring module 201 acquires a current quantity of the records indicating that a transaction is now recorded by the blockchain network. In one embodiment, the acquiring module 201 acquires block data of the blockchain network after the transaction information is broadcast by the trading module 204, and acquires the current quantity of the records according to the block data of the blockchain network.

In one embodiment, the acquiring module 201 acquires a querying time period according to the computing time that the blockchain network spends to build a block according to the computing time, and acquires the current quantity of the records according to the querying time period. In one embodiment, the blockchain network spends 10 minutes to build a block, namely, the querying time period is 10 minutes. The acquiring module 201 acquires a first quantity of the records in a first 10 minutes, and acquires a second quantity of the records in a second 10 minutes, and so on. The process presently disclosed reduces system update time, reduces waiting time, saves server computing resources, and reduces costs by acquiring the current quantity of the records according to the querying time period.

The updating module 205 updates a progress of the transaction according to the current quantity of the records indicating that a transaction is recorded by the blockchain network. In one embodiment, the updating module 205 determines the progress of the transaction by calculating a ratio between the current quantity of the records and the quantity of the records, and updates the determined progress of the transaction. For example, when the current quantity of the records is one, and the quantity of the records is five, the updating module 205 determines that the progress of the transaction is 20% by calculating the ratio between one and five.

The display module 206 displays the progress of the transaction. In one embodiment, the display module 206 displays the progress of the transaction by a progress bar or a progress percentage.

The determining module 207 determines whether the current quantity of the records reaches the quantity of the records. In one embodiment, when the number of new blocks built by the blockchain network is equal to the quantity of the records, the determining module 207 determines that the current quantity of the records reaches the quantity of the records.

In one embodiment, the determining module 207 determines whether the progress of the transaction has an error message. In one embodiment, the error message is the trading information recorded in a tampered block of a malicious node in the blockchain network. For example, the transaction information published by the trader might be “A to B” but the malicious node modifies the transaction information in the tampered block as “A to A”.

In one embodiment, the trading module 204 terminates the transaction when the block in the blockchain network generates an error message before the current quantity of the records reaches the quantity of the records. For example, when detecting that the block corresponding to the malicious node in the blockchain network has maliciously altered the transaction information, the trading module 204 terminates the transaction, thereby, property damage is avoided.

The alarming module 208 sends an alarm message. In one embodiment, the alarming module 208 sends an alarm message when the block in the blockchain network generates the error message before the current quantity of the records reaches the quantity of the records. In one embodiment, the alarming module 208 presents the alarm message by the voice unit 40.

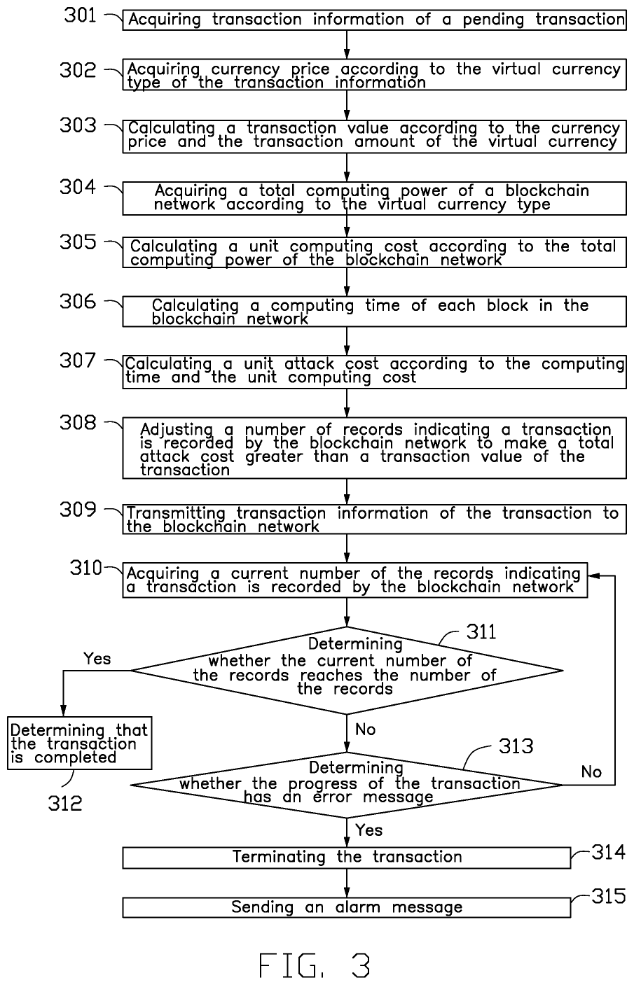

FIG. 3 illustrates a flowchart of an embodiment of a method to prevent a double spend attack. The method is applied in a device to prevent the double spend attack. The method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 301.

At block 301, acquiring transaction information of a pending transaction.

In one embodiment, the device for prevent a double spend attack acquires the transaction information of a pending transaction, and the transaction information includes a type of virtual currency type and a transaction amount of the virtual currency. In one embodiment, the virtual currency includes, but is not limited to, bitcoin, and ether.

In one embodiment, the transaction information further includes transaction price, which is understandably to be the price set by a virtual currency buyer or seller for the virtual currency.

At block 302, acquiring currency price according to the virtual currency type of the transaction information.

In on embodiment, the currency price may be an actual price, that is, a transaction price of the virtual currency at instant trading moment, or an estimated price, which is an average of the trading price over a period of time. In one embodiment, the device acquires a number of trading price of the virtual currency from multiple trading platforms for a preset time period, calculates an average price according to the number of trading price, and regards the average price as the currency price.

At block 303, calculating a transaction value according to the currency price and the transaction amount of the virtual currency.

In one embodiment, the transaction value is an actual value of the virtual currency, calculated by multiplying the currency price by the transaction amount of the virtual currency.

At block 304, acquiring a total computing power of a blockchain network according to the virtual currency type.

In one embodiment, the computing power is a hash rate, and the computing power is an unit of measurement for the blockchain network processing power. Specifically, the computing power is an outputting speed for a computer to calculate a hash function.

In one embodiment, a total computing power of the blockchain network can be an actual computing power value of the blockchain network at present moment, or an average computing power over a period of time, or a pre-estimated computing power value. For example, the total computing power of the blockchain network can be estimated according to a time and a bill difficulty experienced by a competition of absenteeism and accounting rights in the blockchain network during a preset time. In one embodiment, the total computing power of the blockchain network can be a computing power of all mining machines on the blockchain network.

At block 305, calculating a unit computing cost according to the total computing power of the blockchain network.

In one embodiment, the device calculates unit computing power according to the total computing power of the blockchain network, and calculates unit computing cost according to the unit computing power, a hardware cost, and an electricity cost. In one embodiment, the hardware cost includes a purchase cost of the mining machines on the blockchain network and a rental cost, the cost of electricity includes electricity cost of the mining machines. In one embodiment, the unit computing cost includes a technology cost, a labor cost, and a cost of maintaining the mining machines.

At block 306, calculating a computing time of each block in the blockchain network.

For example, in bitcoin blockchain network, building a block in the bitcoin blockchain may actually take 10 minutes, and the new block is broadcast to the entirety of network nodes of the blockchain network. Due to a fluctuation of the total computing power of the blockchain network, the time spend by the bitcoin blockchain to build the block may be different, for example, the time can be 10 minutes and 30 seconds, or can be 9 minutes and 30 seconds.

In one embodiment, the computing time can be a time period of building a new block in the blockchain network, or an average of a number of build times of multiple blocks in the blockchain network.

At block 307, calculating a unit attack cost according to the computing time and the unit computing cost.

In one embodiment, the device calculates the unit attack cost of the double spend attack according to formula P0=p1*S*p2, where p1 is the computing time of each block in the blockchain network, S is the number of blocks built by the attack, and P2 is unit attack cost. For example, the total computing power of the blockchain network is computing power of 100, and the attacker needs to control at least 50% of the total computing power in the blockchain network to launch a double spend attack, computing power of 51 is sufficient. A trader initiates a transaction and sends a true transaction order to the blockchain network, the attacker generates a fake transaction order, and uses a “minority obeys majority” principle in a consensus mechanism to implement a fake transaction order. Such a fake transaction order is to replace the true transaction order and write the fake to a block of the blockchain network, causing the true transaction order to be deleted or tampered with by other target service nodes of the blockchain network. The device calculates the unit attack cost of the double spend attack according to formula P0=p1*51*p2, where p 1 is the computing time of each block in the blockchain network, 51 is the number of blocks built by the attack, and P2 is unit attack cost.

In one embodiment, the method further includes: acquiring a maximum computing power of one node in the blockchain network according to the virtual currency type, and calculating the unit attack cost according to maximum computing power of one node in the blockchain network, the computing time and the unit computing cost.

In one embodiment, the note corresponding to the maximum computing power has a maximum probability value of the accounting rights in the blockchain network. The unit attack cost is not less than a value determined by the maximum computing power multiplying the computing time and the unit computing cost.

At block 308, adjusting a quantity of the records indicating that a transaction is recorded by the blockchain network to make a total attack cost greater than a transaction value of the transaction.

In one embodiment, the total attack cost is determined by multiplying the quantity of the records by the unit attack cost. In one embodiment, the quantity of the records is N and when the transaction occurs, a target block in the blockchain network recording the transaction will be recorded for the first time, and (N−1)records will be recorded in the blocks behind the target block. In one embodiment, the quantity of the records and the transaction are time-stamped on the blockchain, making the quantity of the records and the transaction irreversible and not subsequently alterable. When the quantity of the records reaches a preset quantity of the records, the transaction is successful.

In one embodiment, the device adjusts the quantity of the records according to unit attack cost of the double spend attack, and the transaction value of the transaction to make the total attack cost greater than a transaction value of the transaction. The total attack cost is calculated according to formula P=P0*N, wherein N is the quantity of the records, and P is total attack cost.

In one embodiment, the method further includes: periodically acquiring the currency price, the total attack cost, the unit attack cost, the computing time, and the maximum computing power of one node in the blockchain network. The quantity of the records is adjusted when it is detected that any one of the currency price, the total attack cost, the unit attack cost, the computing time, the maximum computing power of one node in the blockchain network, is changed.

Since the transaction time of virtual currency is relatively long, there are many factors affecting the transaction value of the virtual currency, such as virtual currency price surge, mining machine rent fluctuations, electricity price adjustment, and total computing power. The transaction value or unit attack cost need to be calculated according to the virtual currency price in latest cycle period, and the quantity of the records is adjusted according to the transaction value or unit attack cost. The length of cycle period can be set according to the capability of the mining machine and the fluctuation of the virtual currency, for example, the cycle period can be five minutes.

In one embodiment, the method further includes: when at least one trusted node in the blockchain network has more computing power than that of the other nodes in the blockchain network, periodically adjusting the quantity of the records to a target quantity of the records. In one embodiment, the target quantity of the records is a minimum quantity of the records in completing the transaction. In one embodiment, the trusted node can be a blockchain node for the trader himself, or another blockchain node that the trader can trust.

At block 309, transmitting transaction information of the transaction to the blockchain network.

In one embodiment, the device broadcasts transaction information to the blockchain network to request the blocks in the blockchain network records the transaction information.

At block 310, acquiring a current quantity of the records indicating that a transaction is now recorded by the blockchain network.

In one embodiment, the device acquires block data of the blockchain network after the transaction information is broadcast, and acquires the current quantity of the records according to the block data of the blockchain network.

In one embodiment, the method further includes: acquiring a querying time period according to the computing time that the blockchain network spends to build a block, and respectively acquires the current quantity of the records according to the querying time period.

In one embodiment, the blockchain network spends 10 minutes to build a block, namely, the querying time period is 10 minutes. The acquiring module 201 respectively acquires a first quantity of the records in a first 10 minutes, and acquires a second quantity of the records in a second 10 minutes, and so on. The present disclosure reduces system update time, reduces wait time, saves server computing resources, and reduces costs by acquiring the current quantity of the records according to the querying time period.

In one embodiment, the method further includes: updating a progress of the transaction according to the current quantity of the records indicating a transaction is recorded by the blockchain network, and displaying the progress of the transaction.

In one embodiment, the device determines the progress of the transaction by calculating a ratio between the current quantity of the records and the quantity of the records, and updates the determined progress of the transaction. For example, when the current quantity of the records is one, and the quantity of the records is five, the updating module 205 determines that the progress of the transaction is 20% by calculating a ration between one and five. In one embodiment, the display module 206 displays the progress of the transaction by a progress bar or a progress percentage.

At block 311, determining whether the current quantity of the records reaches the quantity of the records.

In one embodiment, when the number of new blocks built by the blockchain network equals to the quantity of the records, determining that the current quantity of the records reaches the quantity of the records. When the current quantity of the records reaches the quantity of the records, executing block 312, otherwise, executing block 313.

At block 312, determining that the transaction is completed.

In one embodiment, the device determining whether the transaction information is correct, determining that the transaction is completed when the transaction information is correct, and sends an alarm message when the transaction information is not correct.

At block 313, determining whether the progress of the transaction has an error message.

In one embodiment, the error message is the trading information recorded in a tampered block of a malicious node in the blockchain network. The malicious nodes in blockchain network use accounting rights in the blockchain network to modify transaction content in the blocks. For example, the malicious nodes modify transaction information from “A remittance to B” a to “A remittance to C”. For example, the malicious nodes in the blockchain network broadcast two transactions to the blockchain network simultaneously as transaction nodes, wherein one transaction is sent to oneself (in order to increase the success rate of the attack, the transaction adds sufficient fees), and the other transaction is sent to the buyer or seller. Because the two transactions contain higher fees, the probability of being packaged into blocks by miners is higher. In one embodiment, when the progress of the transaction has an error message, executing block 314, otherwise executing block 311.

At block 314, terminating the transaction.

In one embodiment, if an online transaction on a blockchain network fails, the offline transaction or the transaction associated with the virtual currency is terminated, for example, if no virtual currency is received, stopping transferring money to traders.

At block 315, sending an alarm message. In one embodiment, the device sends the alarm message by sound and light, voice, human-machine interface, etc. to inform the relevant person in charge of dealing with an abnormal situation.

The above method and device for prevent a double spend attacks adjust the quantity of the records according to the transaction value and total attack cost, so that the total attack cost is greater than the transaction value, thus preventing the production of the double spend attacks, ensuring the security of large transactions, reducing the quantity of the records of small transactions, and increasing the convenience of small transactions.

The above method and device for prevent a double spend attacks can broadcast trading progress in real time to enable traders to understand trading status in real time. The present disclosure further detects trading information in real time to determine whether there is an error information in the trading information, and to alert the error information to terminate trading, reducing or avoiding trading losses.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for preventing a double spend attack comprising:
acquiring transaction information, wherein the transaction information comprises a virtual currency type and a transaction amount of the virtual currency;
acquiring a currency price according to the virtual currency type of the transaction information;
calculating a transaction value according to the currency price and the transaction amount of the virtual currency;
calculating a unit attack cost corresponding to a blockchain network according to the virtual currency type;
adjusting a quantity of the records indicating a transaction is recorded by the blockchain network to make a total attack cost greater than a transaction value of the transaction, wherein the total attack cost is determined by multiplying the quantity of the records by the unit attack cost; and
transmitting transaction information of the transaction to the blockchain network.

2. The method for preventing a double spend attack according to claim 1, further comprising:
acquiring a total computing power of a blockchain network according to the virtual currency type;
calculating a unit computing cost according to the total computing power of the blockchain network;
calculating a computing time of each block in the blockchain network; and
calculating a unit attack cost according to the computing time and the unit computing cost.

3. The method for preventing a double spend attack according to claim 2, further comprising:
acquiring a current quantity of the records indicating the transaction is recorded by the blockchain network;
determining whether the current quantity of the records reaches the quantity of the records;
when the current quantity of the records reaching the quantity of the records, determining that the transaction is completed.

4. The method for preventing a double spend attack according to claim 3, further comprising:
when the current quantity of the records not reaching the quantity of the records, determining whether a progress of the transaction has an error message;
when the progress of the transaction having an error message, terminating the transaction.

5. The method for preventing a double spend attack according to claim 4, further comprising:
acquiring a querying time period according to the computing time that the blockchain network spends to build a block and acquiring the current quantity of the records according to the querying time period.

6. The method for preventing a double spend attack according to claim 4, further comprising:
updating a progress of the transaction according to the current quantity of the records indicating the transaction is recorded by the blockchain network and displaying the progress of the transaction.

7. The method for preventing a double spend attack according to claim 1, further comprising:
acquiring a maximum computing power of one node in the blockchain network according to the virtual currency type; and
calculating the unit attack cost according to the maximum computing power of one node in the blockchain network, the computing time, and the unit computing cost.

8. The method for preventing a double spend attack according to claim 2, further comprising:
periodically acquiring the currency price, the total attack cost, the unit attack cost, the computing time, the maximum computing power of one node in the blockchain network; and
periodically adjusting the quantity of the records according to the change of one selected from the group consisting of the currency price, the total attack cost, the unit attack cost, the computing time, and the maximum computing power of one node in the blockchain network.

9. The method for preventing a double spend attack according to claim 2, further comprising:
when at least one trusted node in the blockchain network having a more computing power than the computing power of the other nodes in the blockchain network, adjusting the quantity of the records to a target quantity of the records, wherein the target quantity of the records is a minimum quantity of the records in completing the transaction.

10. The method for preventing a double spend attack according to claim 4, further comprising:
sending an alarm message when the block in the blockchain network generates the error message before the current quantity of the records reaches the quantity of the records.

11. A device for preventing a double spend attack comprising:
a processor;
a non-transitory storage medium coupled to the processor and configured to store a plurality of instructions, which cause the processor to:
acquire transaction information, wherein the transaction information comprises a virtual currency type and a transaction amount of the virtual currency;
acquire currency price according to the virtual currency type of the transaction information;
calculate a transaction value according to the currency price and the transaction amount of the virtual currency;
calculate a unit attack cost corresponding to a blockchain network according to the virtual currency type;
adjust a quantity of the records indicating a transaction is recorded by the blockchain network to make a total attack cost greater than a transaction value of the transaction, wherein the total attack cost is determined by multiplying the quantity of the records by the unit attack cost; and
transmit transaction information of the transaction to the blockchain network.

12. The device for preventing a double spend attack according to claim 11, wherein the plurality of instructions further cause the processor to:
acquire a total computing power of a blockchain network according to the virtual currency type;
calculate a unit computing cost according to the total computing power of the blockchain network;
calculate a computing time of each block in the blockchain network; and
calculate a unit attack cost according to the computing time and the unit computing cost.

13. The device for preventing a double spend attack according to claim 12, wherein the plurality of instructions further cause the processor to:
acquire a current quantity of the records indicating the transaction is recorded by the blockchain network;
determine whether the current quantity of the records reaches the quantity of the records;
when the current quantity of the records reaching the quantity of the records, determine that the transaction is completed.

14. The device for preventing a double spend attack according to claim 13, wherein the plurality of instructions further cause the processor to:
when the current quantity of the records not reaching the quantity of the records, determine whether a progress of the transaction has an error message;
when the progress of the transaction having an error message, terminate the transaction.

15. The device for preventing a double spend attack according to claim 14, wherein the plurality of instructions further cause the processor to:
acquire a querying time period according to the computing time that the blockchain network spends to build a block and acquire the current quantity of the records according to the querying time period.

16. The device for preventing a double spend attack according to claim 14, wherein the plurality of instructions further cause the processor to:
update a progress of the transaction according to the current quantity of the records indicating the transaction is recorded by the blockchain network and display the progress of the transaction.

17. The device for preventing a double spend attack according to claim 11, wherein the plurality of instructions further cause the processor to:
acquire a maximum computing power of one node in the blockchain network according to the virtual currency type; and
calculate the unit attack cost according to the maximum computing power of one node in the blockchain network, the computing time, and the unit computing cost.

18. The device for preventing a double spend attack according to claim 12, wherein the plurality of instructions further cause the processor to:
periodically acquire the currency price, the total attack cost, the unit attack cost, the computing time, the maximum computing power of one node in the blockchain network; and
periodically adjust the quantity of the records according to the change of one selected from the group consisting of the currency price, the total attack cost, the unit attack cost, the computing time, and the maximum computing power of one node in the blockchain network.

19. The device for preventing a double spend attack according to claim 12, wherein the plurality of instructions further cause the processor to:
when at least one trusted node in the blockchain network having a more computing power than the computing power of the other nodes in the blockchain network, adjust the quantity of the records to a target quantity of the records, wherein the target quantity of the records is a minimum quantity of the records in completing the transaction.

20. The device for preventing a double spend attack according to claim 14, wherein the plurality of instructions further cause the processor to:
send an alarm message when the block in the blockchain network generates the error message before the current quantity of the records reaches the quantity of the records.
